(19) United States
(12) Patent Application Publication
(10) Pub. No.: US 2023/0259091 A1
(43) Pub. Date: Aug. 17, 2023

(54) SYSTEMS AND METHODS FOR HEATING AND COOLING LOAD DISAGGREGATION

(71) Applicant: Duke Energy Corporation, Charlotte, NC (US)

(72) Inventors: Pu Wang, Charlotte, NC (US); Xihui Dong, Charlotte, NC (US)

(21) Appl. No.: 18/168,918

(22) Filed: Feb. 14, 2023

Related U.S. Application Data
(60) Provisional application No. 63/267,953, filed on Feb. 14, 2022.

(51) Int. Cl. G05B 19/042

(52) U.S. Cl. CPC G05B 19/042; G05B 2219/2639

(57) ABSTRACT

Systems, apparatuses, methods, and computer program products are disclosed for disaggregating seasonal load from overall electricity consumption. An example method includes receiving, by a disaggregation system, historical data comprising (i) historical daily load data for a residence for a particular time period and (ii) an average temperature at the residence for each day in the particular time period. The example method further includes fitting, by the disaggregation system, a data model to the historical data, and calculating, by the disaggregation system and using the data model, an estimated seasonal load for a target time period. The example method further includes causing, by the disaggregation system, one or more notifications to be provided based on the estimated seasonal load for the target time period. Corresponding apparatuses and computer program products are also disclosed.

### CROSS REFERENCE TO RELATED APPLICATIONS

The present application claims the benefit of U.S. Provisional Application No. 63/267,953, filed Feb. 14, 2022, which is hereby incorporated by reference in its entirety.

### BACKGROUND

The present disclosure relates in general to the field of electricity consumption monitoring and management, and more specifically, to systems and methods for disaggregating heating and cooling electricity use from overall residential electricity consumption.

Modern power distribution grids include many generation and transmission resources used to provide power to different types of user loads. Generation and transmission resources may include generators, transmission lines, substations, transformers, etc.

FIG. 1A is a simplified block diagram illustrating an example electrical power distribution environment 100. As shown in FIG. 1A, electric power may be generated at a power generation facility 110 for distribution to residences 130A-130N that consume the generated electric power. Once generated at the power generation facility 110, the electricity may be transmitted to a power distribution grid 120. The power distribution grid 120 may include, for example, power transmission lines between the power generation facility 110 and the residences 130A-130N, as well as one or more substations and other infrastructure (not shown in FIG. 1A) facilitating the distribution of electrical power to the residences 130A-130N. Electric power transmitted to the power distribution grid 120 is thus further delivered to the residences 130A-130N to power various equipment and consumer devices at the residences 130A-130N.

The overall electricity consumption of the residences 130A-130N may be measured by smart meters 140A-140N, each of which is disposed at a corresponding residence. The smart meters 140A-140N may be components of a broader Advanced Metering Infrastructure (AMI), enabling the periodic collection of electricity utilization by the residences 140A-140N.

### BRIEF SUMMARY

Providing residential customers with a meaningful look at their home electricity usage compared to those having similar homes (e.g., based on age, size, location, and heating source) is a key mechanism for allowing users to unilaterally take action to reduce their electricity consumption. And while gaining a holistic view of electricity consumption provides some value, individuals can benefit more directly from a granular understanding of their electricity utilization.

For a residential customer, electricity consumption (load) can be divided into three main categories: “base load,” which refers to the load of the devices that draw electricity consistently; “human activity load,” which refers to the load related to the human activities such as cooking, laundry, water heating; and “seasonal load,” which refers to the electricity consumption for heating and cooling. Typically, the seasonal load contains a large portion of a customer’s electricity consumption. Accordingly, extracting the heating/cooling load from the total load provides customers with greater insight into electricity usage and empowers customers to take steps towards running a more efficient home.

The meters installed at residential properties typically record the total electricity usage and, for most customers, no usage data is available at a more granular level (e.g., by appliance). As a result, developing solutions for disaggregating home electricity usage is a crucial step for providing actionable insight about the usage of residential customers. In particular, heating/cooling load disaggregation is of particular importance because of the large impact seasonal load has on overall electricity consumption.

The current available techniques (in the academia and industry) either use more granular data (electricity usage collected at second or minute intervals) or utilize the installed devices specifically to measure usage by appliances. These methods are not feasible to be productionized for millions of customers. Accordingly, the inventors have determined that a need exists for solutions using AMI data (which captures electricity usage in 15 to 30 minute intervals) at the household level to extract the cooling/heating load.

Systems, apparatuses, methods, and computer program products are disclosed herein for disaggregating seasonal load from overall electricity consumption. As described herein, example embodiments set forth a data-driven solution enabling extraction of the seasonal load from the total load based on AMI data and without requiring bespoke infrastructure modifications. Rather, example embodiments leverage the fact that electricity consumption and weather conditions are highly correlated for a residential customer. In hot days, people turn on the air conditioning to cool down their homes and in cold days they turn on their heaters to warm their houses. Using this known correlation, example embodiments are designed to extract the seasonal load.

An example method is provided herein for disaggregation of seasonal load from overall residential electricity consumption. The example method includes receiving, by a disaggregation system, historical data comprising (i) historical daily load data for a residence for a particular time period and (ii) an average temperature at the residence for each day in the particular time period. The example method further includes fitting, by the disaggregation system, a data model to the historical data, and calculating, by the disaggregation system and using the data model, an estimated seasonal load for a target time period. The example method further includes causing, by the disaggregation system, one or more notifications to be provided based on the estimated seasonal load for the target time period. Corresponding apparatuses and computer program products are also disclosed. Corresponding disaggregation systems and computer program products are also disclosed herein.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1A illustrates a simplified block diagram illustrating an example electrical power distribution environment.

FIG. 1B illustrates a simplified block diagram illustrating an example electrical power distribution environment, in accordance with example embodiments described herein.

FIG. 2 illustrates an example graph showing a typical load plotted against temperature for a single residential customer.

FIG. 3 illustrates an example graph showing a piecewise linear function fitted to a graph of the load plotted against temperature for a single residential customer, in accordance with example embodiments described herein.

FIG. 4 illustrates a schematic block diagram of example circuitry embodying a device that may perform various operations in accordance with example embodiments described herein.

FIG. 5 illustrates an example flowchart for disaggregating seasonal load from overall electricity consumption, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “disaggregation system” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, server devices, and similar electronic devices equipped with at least a processor and any other physical components necessary to perform the various operations described herein.

### Overview

As noted previously, a need exists for solutions enabling the disaggregation of seasonal load from overall electricity utilization for a home. The currently available technologies either use granular data (electricity usage at second or minute intervals) or utilize data from installed devices to specifically measure usage by appliances. However, in the vast majority of settings, high resolution electricity usage data captured at the second or minute interval level is simply not available for many households. Furthermore, there is no realistic way to capture data from installed devices in millions of homes.

Systems, apparatuses, methods, and computer program products are disclosed herein that address these issues by enabling disaggregation of seasonal load from overall electricity consumption using AMI data (which captures electricity usage in 15 to 30 minute intervals) at the household level to extract the cooling/heating load. Example embodiments leverage the fact that electricity consumption and weather conditions are highly correlated for a residential customer. In hot days, people turn on the air conditioning to cool down their homes and in cold days they turn on their heaters to warm their houses. Using this known correlation, example embodiments are designed to extract the seasonal load.

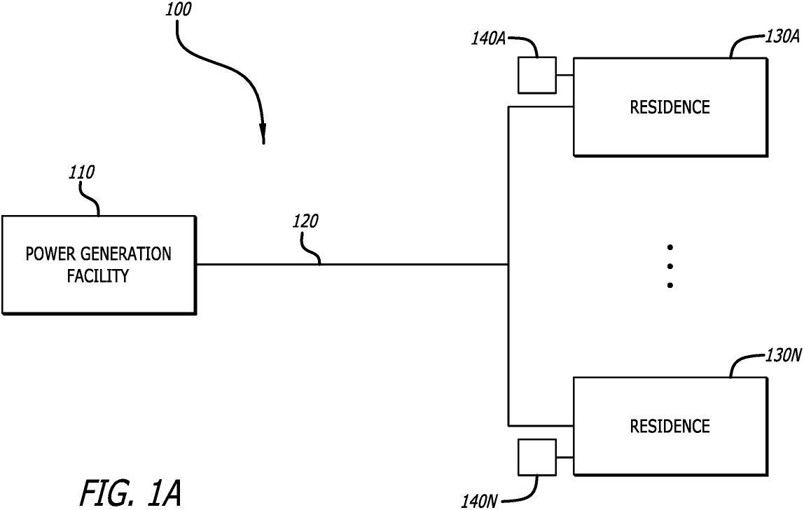

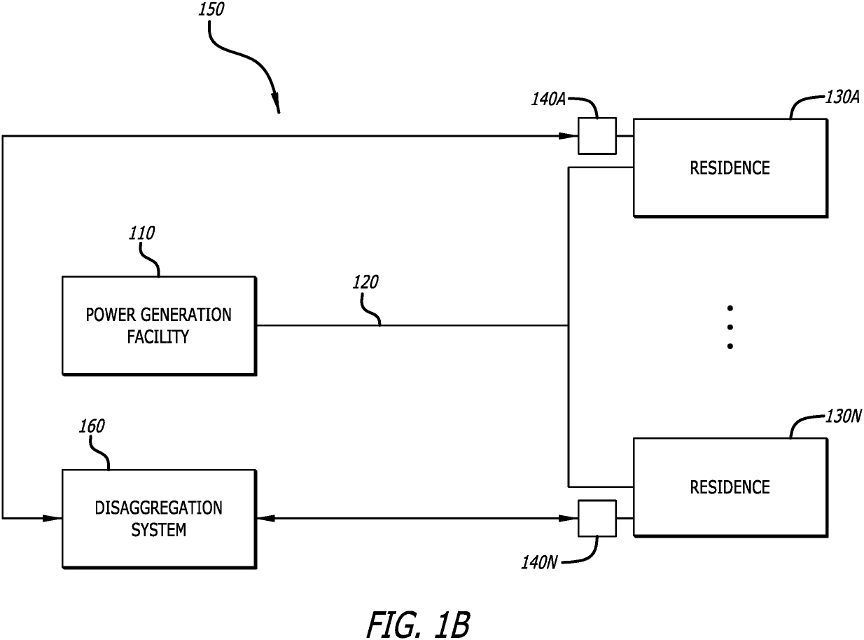

Turning to FIG. 1B, an example electrical power distribution environment 150 is shown that includes the infrastructure described previously in connection with FIG. 1A. In addition, FIG. 1B illustrates an example disaggregation system 160 that may facilitate performance of embodiments described herein. Specifically, the disaggregation system 160 may receive AMI data from the various smart meters 140A-140N, and may utilize that data, in connection with temperature data, to generate a data model for estimating seasonal load for a given residential customer. More specifically, example embodiments utilize this data to model the correlation between the load and temperature by fitting, to the data, a piecewise linear function having three segments corresponding to three zones which include a heating degree zone, a neutral zone, and a cooling degree zone. Here, a heating degree zone refers to temperatures at which a customer residence utilizes heating (e.g., during cold temperature weather), a cooling degree zone refers to temperatures at which a customer residence utilizes cooling (e.g., during hot temperature weather), and a neutral zone refers to temperatures at which a customer residence does not utilize heating or cooling (e.g., during mild temperature weather).

In some embodiments, the disaggregation system 160 may receive the AMI data as soon as the data is collected, measured, or otherwise determined by a corresponding smart meter (e.g., smart meters 140A-140N) such that it is received in substantially real-time or near real-time. As such, the disaggregation system 160 may receive AMI data indicative of electricity usage for a customer residence within the past 15 to 30 minutes. Additionally or alternatively, the disaggregation system 160 may receive AMI data at predefined intervals. For example, the disaggregation system 160 may receive AMI data from a corresponding smart meter (e.g., smart meters 140A-140N) hourly, daily, weekly, etc. The received AMI data may include the electricity usage for the customer residence over the corresponding time period and in 15 to 30 minute intervals. The disaggregation system 160 may store received AMI data in an associated storage.

As mentioned above, the smart meters 140A-140N may collect and provide AMI data pertaining to a residence to disaggregation system 160. In some embodiments, the AMI data may include cumulative kilowatt-hour (kWh) usage, daily kWh usage, peak kilowatt (kW) demand, last interval demand, load profile, voltage, voltage profile, logs of voltage sag and swell events, phase information, outage counts, outage logs, tamper notifications, power factor, time-of-use kWh, peak kW readings, etc. In some embodiments, one or more smart meters 140A-140N may be configured to collect and/or provide temperature measurements using a temperature sensor which is communicatively coupled to one or more smart meters 140A-140N.

In some embodiments, the one or more smart meters 140A-140N may be communicatively coupled to a customer residence thermostat either directly (e.g., wired or wireless) or indirectly using one or more intermediary devices. In some embodiments, the customer residence thermostat may additionally or alternatively be communicatively coupled to disaggregation system 160 either directly (e.g., wired or wireless) or indirectly using one or more intermediary devices. In some embodiments, the disaggregation system 160 may provide one or more control signals to the customer residence thermostat. As such, the disaggregation system 160 may be configured to control heating and/or cooling of the customer residence via the customer residence thermostat.

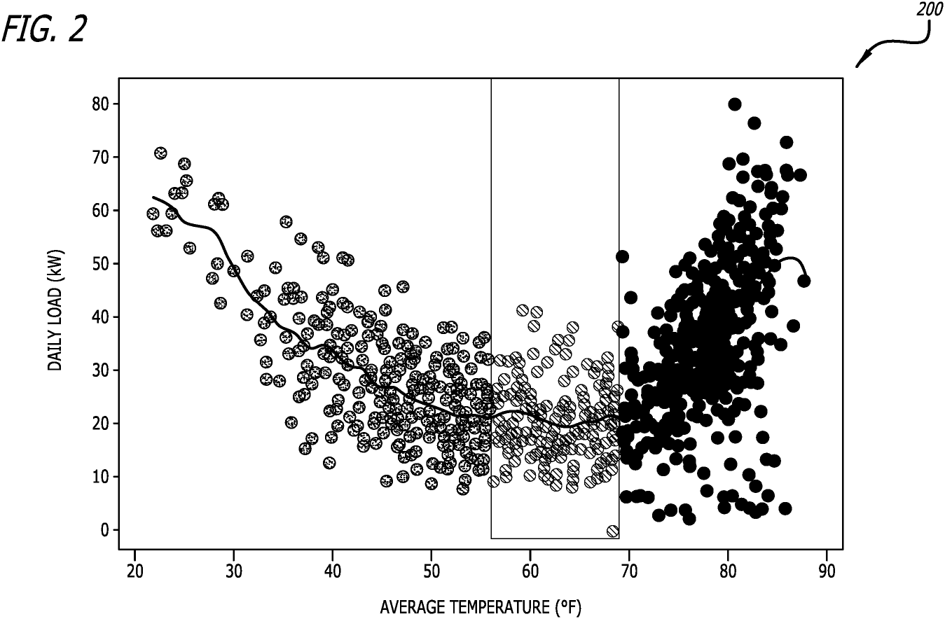

FIG. 2 shows a graph 200 illustrating a typical load plotted against temperature for an example residential customer, using the daily load and daily average temperature. The plot can be divided into three main zones based on temperature. The left wing of the graph represents cold temperature days (e.g., which likely occur during winter months) and is indicative of the heating degree zone, the right wing depicts the hot temperature days (e.g., which likely occur during summer months) and indicative of the cooling degree zone, and the zone in between represents mild temperature days (e.g., which likely occur during shoulder months) and is indicative of the neutral zone.

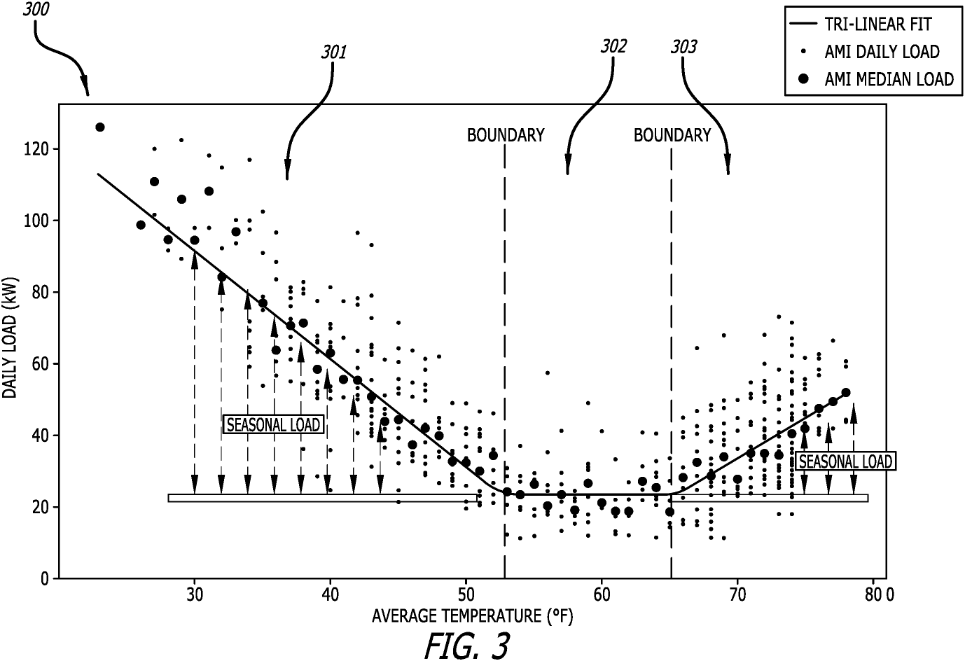

FIG. 3 shows an example of graph 300 depicting a piecewise linear function that has been fitted to example data. As shown in the graph 300, the piecewise linear function may be a “tri-linear” function that has three line segments 301-303 which each correspond to a different zone. The middle segment 302 illustrates a daily load level for the neutral zone (during shoulder months), which comprises the baseline electricity load assuming that there is no cooling/heating in mild temperature days. Comparatively, the left segment 301 illustrates a daily load level for a heating degree zone and the right segment 303 illustrates a daily load level for a cooling degree zone, when heating or cooling is being used, respectively.

Example embodiments estimate seasonal load for a given temperature by calculating the difference between the electric load represented by a point on a line segment corresponding to the given temperature and the baseline electricity load. From this estimated seasonal load, example embodiments in turn may estimate the proportion of electricity on a given day that was used for seasonal load. In certain embodiments, additional steps may be taken to mitigate potential estimation errors, such as adjusting the seasonal cooling estimate to account for pool pump utilization and/or abnormally high cooling load.

By disaggregating seasonal load for a specific home based on that specific home’s overall electricity usage, example embodiments produce an accurate solution overcoming technical hurdles facing prior methods for disaggregating electricity use. Specifically, example embodiments disaggregate seasonal load without requiring deployment of new infrastructure to collect high fidelity data or collect data from the actual heating and cooling devices installed within the house.

Although a high level explanation of the operations of example embodiments has been provided above, specific details regarding the configuration of such example embodiments are provided below.

### Example Implementing Apparatuses

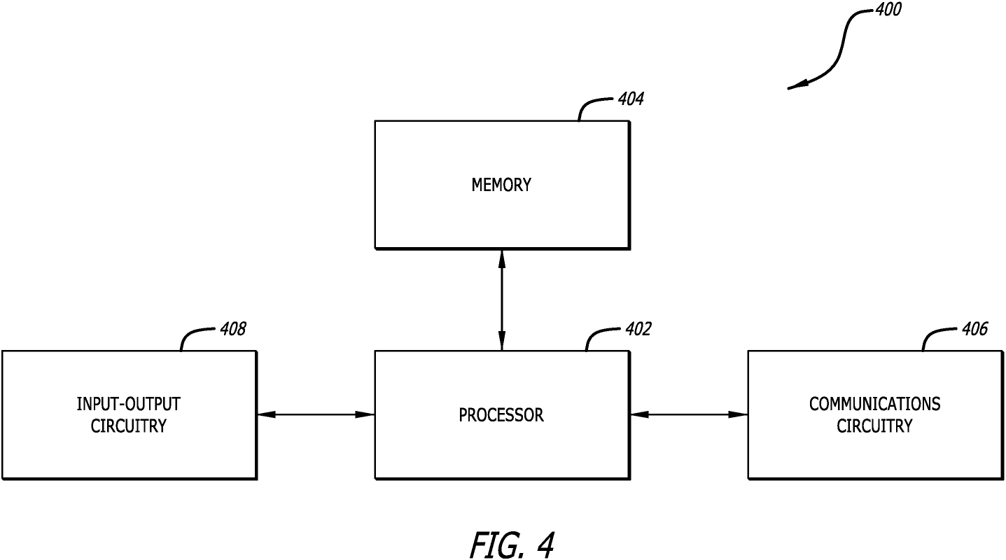

FIG. 4 illustrates an apparatus 400 that may comprise an example disaggregation system 160 that may implement example embodiments described herein. The apparatus may include processor 402, memory 404, communications circuitry 406, and input-output circuitry 408, each of which will be described in greater detail below, along with and any number of additional hardware components not expressly shown in FIG. 4. While the various components are only illustrated in FIG. 4 as being connected with processor 402, it will be understood that the apparatus 400 may further comprises a bus (not expressly shown in FIG. 4) for passing information amongst any combination of the various components of the apparatus 400. The apparatus 400 may be configured to execute various operations described above, as well as those described below in connection with FIG. 4.

The processor 402 (and/or co-processor or any other processor assisting or otherwise associated with the processor) may be in communication with the memory 404 via a bus for passing information amongst components of the apparatus. The processor 402 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 400, remote or “cloud” processors, or any combination thereof.

The processor 402 may be configured to execute software instructions stored in the memory 404 or otherwise accessible to the processor (e.g., software instructions stored on a separate storage device). In some cases, the processor may be configured to execute hard-coded functionality. As such, whether configured by hardware or software methods, or by a combination of hardware with software, the processor 402 represent an entity (e.g., physically embodied in circuitry) capable of performing operations according to various embodiments of the present invention while configured accordingly. Alternatively, as another example, when the processor 402 is embodied as an executor of software instructions, the software instructions may specifically configure the processor 402 to perform the algorithms and/or operations described herein when the software instructions are executed.

Memory 404 is non-transitory and may include, for example, one or more volatile and/or non-volatile memories. In other words, for example, the memory 404 may be an electronic storage device (e.g., a computer readable storage medium). The memory 404 may be configured to store information, data, content, applications, software instructions, or the like, for enabling the apparatus to carry out various functions in accordance with example embodiments contemplated herein. In some embodiments, memory 404 may store AMI data and/or temperature data as received from smart meters 140A-140N.

The communications circuitry 406 may be any means such as a device or circuitry embodied in either hardware or a combination of hardware and software that is configured to receive and/or transmit data from/to a network and/or any other device, circuitry, or module in communication with the apparatus 400. In this regard, the communications circuitry 406 may include, for example, a network interface for enabling communications with a wired or wireless communication network. For example, the communications circuitry 406 may include one or more network interface cards, antennas, buses, switches, routers, modems, and supporting hardware and/or software, or any other device suitable for enabling communications via a network. Furthermore, the communications circuitry 406 may include the processing circuitry for causing transmission of such signals to a network or for handling receipt of signals received from a network.

The apparatus 400 may include input-output circuitry 408 configured to provide output to a user and, in some embodiments, to receive an indication of user input. It will be noted that some embodiments will not include input-output circuitry 408, in which case user input may be received via a separate device. The input-output circuitry 408 may comprise a user interface, such as a display, and may further comprise the components that govern use of the user interface, such as a web browser, mobile application, dedicated client device, or the like. In some embodiments, the input-output circuitry 408 may include a keyboard, a mouse, a touch screen, touch areas, soft keys, a microphone, a speaker, and/or other input/output mechanisms. The input-output circuitry 408 may utilize the processor 402 to control one or more functions of one or more of these user interface elements through software instructions (e.g., application software and/or system software, such as firmware) stored on a memory (e.g., memory 404) accessible to the processor 402.

In some embodiments, various components of the apparatus 400 may be hosted remotely (e.g., by one or more cloud servers) and thus not all components must reside in one physical location. Moreover, some of the functionality described herein may be provided by third party circuitry. For example, apparatus 400 may access one or more third party circuitries via any sort of networked connection that facilitates transmission of data and electronic information between the apparatus 400 and the third party circuitries. In turn, the apparatus 400 may be in remote communication with one or more of the components describe above as comprising the apparatus 400.

As will be appreciated based on this disclosure, some example embodiments may take the form of a computer program product comprising software instructions stored on at least one non-transitory computer-readable storage medium (e.g., memory 404). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 400 as described in FIG. 4, that loading the software instructions onto a computing device or apparatus produces a special-purpose machine comprising the means for implementing various functions described herein.

Having described specific components of the apparatus 400, example embodiments are described below.

### Example Operations

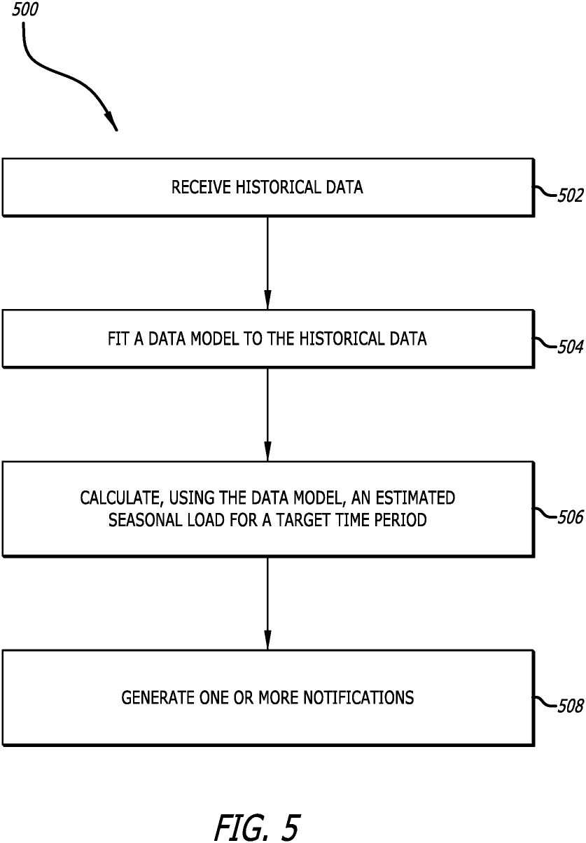

Turning to FIG. 5, an example flowchart is illustrated that contains example operations implemented by various embodiments contemplated herein. The operations illustrated in FIG. 5 may, for example, be performed by an apparatus 400, which is shown and described in connection with FIG. 4. To perform the operations described below, the apparatus 400 may utilize one or more of processor 402, memory 404, communications circuitry 406, input-output circuitry 408, other components, and/or any combination thereof. It will be understood that user interaction with the apparatus 400 may occur directly via input-output circuitry 408, or may instead be facilitated by a device that in turn interacts with apparatus 400.

As shown by operation 502, the apparatus 400 includes means, such as processor 402, memory 404, communications circuitry 406, input-output circuitry 408, or the like, for receiving historical data. The historical data may comprise (i) historical daily load data for a residence for a particular time period and (ii) an average temperature at the residence for each day in the particular time period. This historical data may be received via communications circuitry 406 from any number of sources, such as a smart meter connected to the residence, one or more third party devices, or the like. In some embodiments, this historical data may be stored by the apparatus 400, such as in a memory 404. In some embodiments, some portion of this historical data may be received from a user via input-output circuitry 408.

In some embodiments, the temperature collected for the residential customer may refer to the environmental temperature. The environmental temperature may refer to the temperature of the environment external to the residence. The environmental temperature may be collected by a temperature sensor communicatively coupled with any one or more of smart meters 140A-140N such that the AMI data may include the temperature measurements or may be determined by apparatus 400 using one or more external data sources (e.g., temperature information provided by a weather channel). The apparatus 400 may store the temperature data in an associated memory and may also include a timestamp indicating the date and time when the temperature measurement was collected or otherwise determined. In some embodiments, the temperature data may be stored with received AMI data such that it may be included in the historical data.

The apparatus 400 may determine the average temperature value based on received temperature data and/or determined temperature data as described by the historical data. The apparatus 400 may access stored temperature data and use the temperature data corresponding to a particular time period (e.g., temperature data corresponding to a particular day as indicated by a timestamp associated with a temperature data value) to determine the average temperature. For example, the apparatus 400 may access all temperature data collected for a residence over for a particular date and then average the temperature data to determine the average temperature value for the day. The average temperature value may be rounded to a predefined number of significant figures. Although the daily average temperature value is described, other average temperature time periods (e.g., hourly average temperature value, weekly average temperature value, monthly average temperature value, etc.) may additionally be contemplated.

Similarly, in some embodiments, the apparatus 400 may determine the daily load value based on the AMI data received from the smart meters 140A-140N as described by the historical data. The apparatus 400 may access stored AMI data and use AMI data corresponding to a particular time period (e.g., AMI data corresponding to a particular day as indicated by a timestamp associated with an AMI data value) to determine the daily load value. For example, the apparatus 400 may access all AMI data collected over a particular time period (e.g., within 15 to 30 minute intervals) for a residence over for a particular date and then sum the AMI data together to determine the daily load value. Alternatively, in some embodiments, the historical data may already include the daily load value such that no such calculations are required. Although the daily load value is described, other load value time periods (e.g., hourly load value, weekly load value, monthly load value, etc.) may additionally be contemplated.

The historical data may include data points collected within a particular time period. For example, the data points included within the historical data may include only data points collected within the past 5 years. In some embodiments, the particular time period used may depend on one or more trigger events. Trigger events may correspond to a particular circumstance which may cause future electrical load usage for a particular residence to deviate from historical electrical load usage. For example, a trigger event may be an HVAC replacement, window replacement, new residents, and/or the like.

As shown by operation 504, the apparatus 400 includes means, such as processor 402, memory 404, communications circuitry 406, input-output circuitry 408, or the like, for fitting a data model to the historical data. The data model may comprise a piecewise linear function. In some embodiments, the piecewise linear function may be a “tri-linear” function that has three line segments, one of which estimates a baseline daily load for the residence, another of which estimates an overall daily load for the residence inclusive of seasonal load during colder days (e.g., a baseline daily load inclusive of seasonal heating load), and another of which estimates an overall daily load for the residence inclusive of seasonal load during warmer days (e.g., a baseline daily load inclusive of seasonal cooling load). The apparatus 400 may fit the data model to the historical data using regression, segmented regression, or any other suitable approach for fitting a data model to the historical data.

In particular, each line segment may correspond to a particular zone (e.g., heating degree zone, neutral zone, and cooling degree zone). Within each zone, the median daily load values (e.g., the median daily load values associated with average temperatures which fall within the temperature range of the particular zone) are fit to the respective historical data. This separate fitting yields three line segments whose slopes are independent from one another. In some embodiments, the piecewise linear function is a connected piecewise linear function such that the daily median load values at a boundary (e.g., the average temperature value at the extremes of a particular temperature range for a zone) is the same between the two adjacent zones. Additionally, the slope of the line segment (e.g., the middle line segment) corresponding to the neutral zone may be set to 0. This may allow the middle line segment to be used as a baseline daily load during additional calculations.

Each zone may correspond to a particular temperature range, which may define the boundaries for a given zone. For example, the heating degree zone may correspond to temperatures values less than or equal 55° F., the neutral zone may correspond to temperatures between 55° F. to 70° F., and the cooling degree zone may correspond to temperatures greater than or equal to 70° F. Here, the average temperature boundaries are 55° F. as shared by the heating degree zone and neutral zone and 70° F. as shared by the cooling degree zone and the neutral zone. The boundaries and/or temperature ranges for a given zone may be set and/or modified by an authorized user (e.g., an administrator with administrator rights to apparatus 400) or may be automatically determined.

In an instance the temperature ranges are determined automatically, the apparatus 400 may determine a median daily load value by determining the median value for the daily load values at a given temperature. Alternatively, an average daily load value may be determined for a given temperature by averaging each daily load value for a given temperature. A subset of adjacent median daily load points may then be selected and fitted with a linear trendline. The slope of the linear trendline and R-squared coefficient may be determined for a given subset of adjacent median daily load points. A new adjacent median daily load point may then be appended to the subset of adjacent median daily load points may and a new linear trendline may be fitted and the slope and R-squared coefficient calculated. This process may iteratively repeat until the addition of an adjacent median daily load point causes the slope of the line to deviate by a predefined amount or percentage of the original trendline or one or more previous trendlines or the R-squared coefficient value falls below an R-squared coefficient value. Thus, the average temperature value of the median daily load point which causes this may be determined to be a boundary condition and may be used to define the start or end of a particular zone. The boundary condition may reflect the average temperature at which a customer residence begins to use heating or cooling. In some embodiments, the above describe process may be started at the extreme ends of the set of median daily load values such that the first median daily load point and last median daily load point are used as starting points for these calculations. Alternatively, the process may be started at a median daily load located at a particular average temperature. For example, a median load data point corresponding to the neutral zone may be selected and used to determine the boundaries on either side of the zone.

In some embodiments, apparatus 400 may determine whether the automatically generated boundary conditions satisfy one or more boundary condition thresholds set for a particular zone. In an instance the automatically generated boundary conditions for a particular zone fail to satisfy the one or more boundary condition thresholds for the zone, then apparatus 400 may use predetermined values for the boundary condition. In some embodiments, a predetermined value may be equivalent to a boundary condition threshold. For example, a heating degree zone may have a boundary condition threshold of 60° F. As such, if apparatus 400 determines a boundary condition for the heating degree zone to be greater than 60° F., then apparatus 400 may determine the boundary condition for the zone to be 60° F. (e.g., the boundary condition threshold for the heating degree zone).

As shown by operation 506, the apparatus 400 includes means, such as processor 402, memory 404, communications circuitry 406, input-output circuitry 408, or the like, for calculating, using the data model, an estimated seasonal load for a target time period. The target time period may be within the particular time period (e.g., corresponding to the time and/or dates of the historical data), outside the particular time period, or may overlap the particular time period. For example, the target time period may be within the last 30 days and historical data collected over the past 5 years may be used to fit the data model. The apparatus may calculate the estimated seasonal load for the target time period by generating an estimated seasonal load for each day within the target time period, and calculating a sum including the estimated seasonal load for each day within the target time period, wherein the sum comprises the estimated seasonal load for the target time period.

To this end, the apparatus 400 may calculate the estimated seasonal load for a particular day within the target time period. In particular, for a given day, apparatus 400 may identify an average temperature for the particular day and determining, using the data model fit with historical data and the average temperature, an overall daily load for the given day. The apparatus may then subtract the baseline daily load (e.g., the daily load value associated with the middle line segment) from the overall daily load to produce the estimated seasonal load for the particular day. This may be repeated for each day within a target time period and then the corresponding estimated seasonal loads for each particular day may be summed to yield the estimated seasonal load for the target time period.

In some embodiments, the apparatus 400 may adjust the estimated seasonal load for a particular day. For instance, pool pumps are major appliances whose utilization may not be appropriately disaggregated from the seasonal load. Pool pumps are one of the major appliances other than central air conditioning that prominently runs during summers only. Most customers winterize their pool (and do not use their pool pump) during winter and fall seasons. For these accounts with winterized pool, the seasonal disaggregation also retains the pool pump load, because the daily baseline load does not reflect pool pump utilization. Hence, to get a more accurate estimate of seasonal load during the hot temperature months (e.g., which is an estimation of cooling seasonal load), the apparatus 400 may estimate and deduct pool pump energy use from the estimated seasonal load for the particular day during days that occur during the summer (for those residences known to have a pool). In some embodiments, the value of the pool pump energy use may be a value set by an administrator and may be a value determined based on a theoretical or average pool pump energy use.

In some embodiments, apparatus 400 may store a list of residences associated with pools and access this list to determine whether an estimated pool pump energy use should be deducted from the estimated seasonal loads for each particular day. In some embodiments, confirmation of whether a customer residence is associated with a pool may be obtained during account onboarding, via a provided questionnaire, and/or the like. The value of the estimated pool pump energy use may be a value set by an administrator (e.g., an administrator with administrator rights to apparatus 400) and/or may be based on theoretical load value.

Additionally, or alternatively, the apparatus 400 may utilize a seasonal cooling load cap, because seasonal cooling load sometimes reflects an abnormally high cooling load. In some cases, this is because of farm activities or because homes are rental properties where electrical usage is generally more aggressive. In general, this phenomenon is likely due to the utilization of major equipment operating during the summer that apparatus 400 lacks information for. Hence, it cannot always be assumed that the increase in load during summer is from HAVC cooling. Therefore, in some embodiments, a theoretical calculation of the HVAC load may be deployed in comparison to the seasonal disaggregation obtained from the data model as illustrated above. The theoretical HVAC load may, for instance, be obtained following the approach published by the National Renewable Energy Laboratory (NREL) in 2013 as Technical Report NREL/TP-5500-56354 by D. Cutler et al., titled Improved Modeling of Residential Air Conditioners and Heat Pumps for Energy Calculations. Theoretical HVAC load may be calculated based on the type of cooling system (e.g., Central A/C or Heat Pump), the square footage of the house, the climate zone, and the age of house, which may in turn yield the size of the HVAC, design temperatures, the age of HVAC for energy efficiency, and cooling degree days for the month. From those values, an ideal theoretical energy usage for cooling for the month may be calculated.

In some embodiments, the type of cooling system, square footage of the house, climate zone, and the age of the house may be determined by apparatus 400 in order to calculate the theoretical HVAC load. For example, apparatus 400 may receive parameters as indicated by the customer (e.g., such as during onboarding, from questionnaires, etc.) or via external data sources (e.g., real estate sites or the like). Once apparatus 400 has obtained these parameters, apparatus 400 may be configured to determine the theoretical HVAC load for the particular customer residence. The cooling load cap may then be determined based on the theoretical HVAC load.

To implement a cooling load cap of this nature, the apparatus 400 may identify, in an instance in which an average seasonal load for the particular day exceeds a threshold (e.g., a predefined threshold above which the residence is predicted to be using seasonal cooling), a cooling load cap based on the theoretical HVAC calculation of seasonal cooling load for the residence using a methodology such as that set forth above. In an instance in which the estimated seasonal load for the particular day exceeds the cooling load cap, the apparatus 400 may reduce the estimated seasonal load for the particular day to the cooling load cap. Because the calculation of a cooling load cap as set forth above may not take in account the factors such as house orientation, insulation, or other residence-specific factors, in some embodiments the apparatus 400 may scale the cooling load cap by a predefined factor (e.g., 1.5). In some embodiments, the final obtained energy usage (e.g., as determined using the predefined factor) may in some embodiments, be used as a cooling load cap for the estimated cooling load (e.g., if the cooling load obtained from the data model is higher than 1.5 times of the theoretical cooling kWh, such embodiments may restrict the cooling load to 1.5 times of the theoretical cooling kWh).

Finally, as shown by operation 508, the apparatus 400 includes means, such as processor 402, memory 404, communications circuitry 406, input-output circuitry 408, or the like, for generating one or more notifications based on the estimated seasonal load for the target time period. In some embodiments, the one or more notifications may be messages (e.g., via website interface, mobile app, a targeted email, a targeted mail campaign, or the like) which cause presentation of information regarding the estimated seasonal load for the target time period to displayed to a recipient via his/her user device. Moreover, the information regarding the estimated seasonal load for the target time period may be presented in connection with an overall electric consumption data (e.g., as a percentage of overall energy use). In some embodiments, the information may be presented in relation to historical data regarding seasonal load for the residence to enable a residential customer to understand changes in seasonal load over time that may drive further decision-making by a user.

Additionally, or alternatively, apparatus 400 may leverage the estimated seasonal load for the target time period as well as historical data regarding the seasonal load for the residence to determine one or more recommendations for the customer residence. In some embodiments, apparatus 400 may access and use a recommendation model to determine the one or more recommendations. The recommendation model may be stored in an associated memory (e.g., memory 404). The recommendation model may employ one or more machine learning techniques or deep learning techniques to process the estimated seasonal load for the target time period as well as historical data regarding the seasonal load for the residence to determine one or more root causes (e.g., a contributory factor) for a high seasonal load and generate one or more recommendations. For example, a rising seasonal load (e.g., as compared to historical seasonal loads) for the customer residence may indicate faltering HVAC equipment such that apparatus 400 may determine the HVAC unit is a root cause and thus recommend the HVAC equipment be replaced. As another example, a rising seasonal load may indicate drafty or leaky windows, which can lead to undesirable heat transfer to occur between the outside environment and interior of the customer residence and contribute to high seasonal load. As such, apparatus 400 may determine older windows as a root cause and recommend the older windows of the residence be replaced.

In some embodiments, the recommendation model may additionally process data pertaining to the customer residence (e.g., date describing when the residence was built, date of remodeling projects, the type of equipment used by the residence (e.g., HVAC units, pool pumps, etc.), model and/or serial numbers of equipment, age of equipment, and/or the like) which may be used as additional parameters by the recommendation model when determining the root cause and the one or more recommendations. The recommendation model may be trained to weight certain parameters of the customer residence based on their respective influence on and/or contribution to seasonal load. As such, the recommendation model may be better able to determine a root cause of high seasonal load based on the customer residence data. For example, if the customer residence data indicates a new HVAC unit has been installed but the windows of a 30-year old residence have never been replaced and the seasonal load remains high, then recommendation model may determine that the customer residence should replace the older windows. The recommendation model may output the one or more recommendations in any suitable format (e.g., a list, vector, string, and/or the like) such that apparatus 400 may include the one or more recommendations in the one or more notifications.

In some embodiments, apparatus 400 may generate an average estimated seasonal load for a target region (e.g., city, state, climate, or other geographical location) within which the customer residence is located based on the estimated seasonal load for the target time period for all customer residences within the particular target region. For example, apparatus 400 may average the estimated seasonal load for the target time period for all customer residences within the particular target region to determine an average estimated seasonal load for the target region. Alternatively, apparatus 400 may select only a subset of customer residences within the target region and average the estimated seasonal load for the selected customer residences to determine an average estimated seasonal load. In some embodiments, apparatus 400 may use one or more algorithms (e.g., K-means clustering algorithms and/or the like) to remove any customer residence outliers from consideration and select the customer residences which are not removed via the one or more algorithms as the subset of customer residences. This may allow the average estimated seasonal load for the target region may be more accurate and representative of the true average estimated seasonal load for the target region. Apparatus 400 may include the average estimated seasonal load for the target region may be included in the one or more notifications for the customer such that the customer may be made aware of how his/her particular residence compares to the average estimated seasonal load for the target time in the target region.

In some embodiments, apparatus 400 may generate a notification that directly or indirectly causes a customer thermostat to operate in a particular operational status (e.g., “heating” or “cooling” and “on” or “off”) for a given time period. In particular, customers may choose to opt-in to a program which allows apparatus 400 to control the corresponding customer residence thermostat in response to certain trigger conditions. A trigger condition may be set by a customer and/or may be set by one or more predefined rules and/or conditions associated with the customer residence. Each trigger condition may also be associated with an operational status of the customer thermostat (e.g., “heating” or “cooling” and “on” or “off”). Additionally, each trigger condition may be associated with one or more threshold values, which apparatus 400 may use to determine whether the trigger condition has been met. The predefined rules and/or conditions may be based on the estimated seasonal load for the target time period and/or a forecasted seasonal load for a new target time period. Apparatus 400 may determine forecasted seasonal load for a new target time period based on the current estimated seasonal load for the target time period (e.g., the seasonal load the customer residence has currently used). Apparatus 400 may also use forecasted temperature data and/or historical data to extrapolate the current estimated seasonal load and determine the forecasted seasonal load for the new target time period using any suitable algorithms and/or operations (e.g., regression algorithms, machine learning techniques, etc.).

In some embodiments, a trigger condition may describe an estimated daily load threshold value and a corresponding operational status. For example, apparatus 400 may be configured to determine an estimated current load (e.g., the load the customer residence has currently used) and a forecasted estimated daily load (e.g., determined based on the estimated current load, historical data, and/or forecasted temperature data) and determine a forecasted estimated load for a new target time period. In the instance apparatus 400 determines the forecasted estimated load does not satisfy an estimated daily load threshold value (e.g., is greater than the estimated daily load threshold value), apparatus 400 may provide a notification to the customer residence thermostat or an intermediary device communicatively coupled to the customer residence thermostat to cause the customer thermostat to switch to the described operational status (e.g., turn off heating or cooling operations) for a particular amount of time (e.g., 1 hour).

In some embodiments, a trigger condition may describe an estimated seasonal load threshold value and a corresponding operational status. For example, apparatus 400 may be configured to determine an estimated current seasonal load (e.g., the seasonal load the customer residence has currently used) and a forecasted estimated seasonal load (e.g., determined based on the estimated current seasonal load and historical data) and determine a forecasted estimated seasonal load for the new target time period. In the instance apparatus 400 determines the forecasted estimated seasonal load does not satisfy an estimated seasonal load threshold value, apparatus 400 may provide a notification to the customer residence thermostat or an intermediary device communicatively coupled to the customer residence thermostat to cause the customer thermostat to switch to the described operational status for a particular amount of time, as described above.

In some embodiments, a trigger condition may describe a target region comparative threshold value and an operational status. A target region comparative threshold value may be determined based on a comparison between an estimated seasonal load value of the residence and an average estimated seasonal load for the target region. In some embodiments, the target region comparative threshold value may be a numerical value (e.g., 10 kW higher than the average estimated seasonal load for the target region) or a percentage (e.g., 10% higher than the average estimated seasonal load for the target region) which is determined based on the average estimated seasonal load for the target region. For example, in the instance apparatus 400 determines the forecasted estimated seasonal load does not satisfy the target region comparative threshold value (e.g., 10% higher) as compared to the average estimated seasonal load for the target region, apparatus 400 may provide a notification to the customer residence thermostat or an intermediary device communicatively coupled to the customer residence thermostat to cause the customer thermostat to switch to the described operational status for a particular amount of time, as described above.

In some embodiments, a trigger condition may describe a monetary threshold value over a particular time frame (e.g., daily, weekly, monthly, etc.) rather than a particular energy load for a residence. In general, electricity consumption may be associated with a market monetary value, which may be based on current market values and/or the particular target region in which the customer residence is located. For example, a kWh for a region may be associated with a market monetary value of 12 cents. Apparatus 400 may determine a forecasted cost for a customer residence over a new target time period based on the forecasted estimated seasonal load during the time frame and the current market monetary value. For example, a customer residence which is determined to have a forecasted energy usage of 40 kWh and therefore may be determined to have a forecasted cost of about 4.80 dollars. Thus, in this example, a monetary threshold value of 4.50 dollars may cause apparatus 400 to provide a notification to the customer residence thermostat or an intermediary device communicatively coupled to the customer residence thermostat to cause the customer thermostat to turn off heating or cooling operations for a particular amount of time. In some embodiments, a customer may set a particular time frame, which may be used to set sub-monetary threshold values over interval time frames. For example, a customer may set a maximum limit of 160.00 dollars per month as the monetary threshold value. As such, apparatus 400 may apportion a sub-monetary threshold value of 5.33 dollars for each day during a 30 day month.

Additionally, in some embodiments, a trigger condition may correspond to a target region as a whole such that apparatus 400 may generate and/or provide notifications to one or more customer residences within the target region based on the estimated seasonal load of the target region and based on one or more resource availability threshold values. In particular, apparatus 400 may determine one or more resource availability threshold values for the target region. For example, a resource availability threshold value may describe an overall electrical load available to the target region as a whole as provided by a utility company for a predetermined cost to the utility company. This resource availability threshold value may be determined based on the total amount of energy available to the utility company without the utility company having to introduce energy from another energy source and/or provider. Additionally, or alternatively, a resource availability threshold value may be determined based a particular monetary cost threshold value associated with the cost for the utility company to provide a total amount of energy to the target region over a particular time frame.

In particular, apparatus 400 may sum the estimated seasonal load values of each customer residence within the target region to determine a total estimated seasonal load usage value for the target region. Additionally, apparatus 400 may sum the forecasted estimated seasonal load values for each customer residence within the target region to determine a total forecasted estimated seasonal load value for the target region during the new target time period. Apparatus 400 may then compare the total estimated seasonal load usage value for the target region and/or total forecasted estimated seasonal load usage value for the target region to one or more resource availability thresholds. In an instance apparatus 400 determines either the total estimated seasonal load usage value and/or the total forecasted estimated seasonal load usage value does not satisfy the one or more resource availability threshold values (e.g., either based on total amount of energy available and/or monetary cost threshold value), apparatus 400 may determine a subset of customer residences to provide the one or more notifications, which will cause the corresponding customer residence thermostats to switch to the described operational status for a particular amount of time, as described above.

In some embodiments, apparatus 400 may determine the subset of houses based on a maximum estimated seasonal load threshold value. The maximum estimated seasonal load threshold value may be determined by the one or more resource availability threshold values. For example, apparatus 400 may divide and apportion the resource availability values equally amongst each customer residence within the target region and the value allocated to each customer residence may be used to determine the maximum estimated seasonal load threshold value, directly (e.g., in instances where the resource availability values indicate total estimated seasonal load) or indirectly (e.g., in instances where the resource availability values indicate monetary cost values). Apparatus 400 may determine to add a customer residence to the subset of customer residences in an instance the customer residence is determined to be associated with an estimated seasonal load value which does not satisfy the maximum estimated seasonal load value threshold value. In some embodiments, apparatus 400 may use or more algorithms (e.g., K-means clustering algorithms and/or the like) to identify any customer residences that are associated with estimated seasonal load values that are outliers from the average estimated seasonal load values for the particular target region. As such, apparatus 400 may generate and provide notifications to the one or more customer residences which may be associated with particularly high seasonal load values and cause the customer thermostat of these customer residences to operate in a particular operational status to thereby reduce the associated energy usage from these customer residences.

It will be appreciated that operations 502-508 may be repeated frequently and/or periodically. For instance, the apparatus 400 may receive updated historical data periodically, and may fit a new data model to the updated historical data to permit revised calculations of estimated seasonal load.

FIG. 5 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for disaggregating seasonal load from overall electricity consumption, the method comprising:
receiving, by a disaggregation system, historical data comprising (i) historical daily load data for a residence for a particular time period and (ii) an average temperature at the residence for each day in the particular time period;
fitting, by the disaggregation system, a data model to the historical data;
calculating, by the disaggregation system and using the data model, an estimated seasonal load for a target time period; and
causing, by the disaggregation system, one or more notifications to be provided based on the estimated seasonal load for the target time period.

2. The method of claim 1, wherein the data model comprises a piecewise linear function.

3. The method of claim 2, wherein the piecewise linear function has three line segments, one of which estimates a baseline daily load for the residence.

4. The method of claim 1, wherein the disaggregation system applies segmented regression to fit the data model to the historical data.

5. The method of claim 1, wherein the target time period is within the particular time period, is outside the particular time period, or overlaps the particular time period.

6. The method of claim 1, wherein calculating the estimated seasonal load for the target time period includes:
generating, by the disaggregation system, an estimated seasonal load for each day within the target time period; and
calculating, by the disaggregation system, a sum including the estimated seasonal load for each day within the target time period, wherein the sum comprises the estimated seasonal load for the target time period.

7. The method of claim 6, wherein calculating the estimated seasonal load for a particular day within the target time period includes:
identifying, by the disaggregation system, an average temperature for the particular day;
determining, by the disaggregation system and using the data model and the average temperature, an overall daily load and a baseline daily load; and
subtracting, by the disaggregation system, the baseline daily load from the overall daily load to produce the estimated seasonal load for the particular day.

8. The method of claim 7, further comprising:
adjusting, by the disaggregation system, the estimated seasonal load for the particular day.

9. The method of claim 8, wherein adjusting the estimated seasonal load for the particular day includes:
deducting, by the disaggregation system, pool pump electricity use from the estimated seasonal load for the particular day.

10. The method of claim 7, wherein, in an instance in which an average temperature for the particular day exceeds a threshold, adjusting the estimated seasonal load for the particular day includes:
identifying, by the disaggregation system, a cooling load cap based on a theoretical calculation of seasonal cooling load for the residence; and
in an instance in which the estimated seasonal load for the particular day exceeds the cooling load cap, reducing, by the disaggregation system, the estimated seasonal load for the particular day to the cooling load cap.

11. An apparatus for disaggregating seasonal load from overall electricity consumption, the apparatus comprising a processor and a memory storing software instructions that, when executed by the processor, cause the apparatus to:
receive historical data comprising (i) historical daily load data for a residence for a particular time period and (ii) an average temperature at the residence for each day in the particular time period;
fit a data model to the historical data;
calculate, using the data model, an estimated seasonal load for a target time period; and
cause one or more notifications to be provided based on the estimated seasonal load for the target time period.

12. The apparatus of claim 11, wherein the data model comprises a piecewise linear function.

13. The apparatus of claim 12, wherein the piecewise linear function has three line segments, one of which estimates a baseline daily load for the residence.

14. The apparatus of claim 11, wherein the disaggregation system applies segmented regression to fit the data model to the historical data.

15. The apparatus of claim 11, wherein the software instructions, when executed by the processor and when calculating the estimated seasonal load for the target time period, further cause the apparatus to:
generate an estimated seasonal load for each day within the target time period; and
calculate a sum including the estimated seasonal load for each day within the target time period, wherein the sum comprises the estimated seasonal load for the target time period.

16. The apparatus of claim 15, wherein the software instructions, when executed by the processor and when calculating the estimated seasonal load for a particular day within the target time period, further cause the apparatus to:
Identify an average temperature for the particular day;
determine, using the data model and the average temperature, an overall daily load and a baseline daily load; and
subtract the baseline daily load from the overall daily load to produce the estimated seasonal load for the particular day.

17. The apparatus of claim 16, wherein the software instructions, when executed by the processor, further cause the apparatus to:
adjust the estimated seasonal load for the particular day.

18. The apparatus of claim 17, wherein the software instructions, when executed by the processor and when adjusting the estimated seasonal load for the particular, further cause the apparatus to:
deduct pool pump electricity use from the estimated seasonal load for the particular day.

19. The apparatus of claim 17, wherein the software instructions, when executed by the processor and when adjusting the estimated seasonal load for the particular day in an instance in which an average temperature for the particular day exceeds a threshold, further cause the apparatus to:
identify a cooling load cap based on a theoretical calculation of seasonal cooling load for the residence; and
in an instance in which the estimated seasonal load for the particular day exceeds the cooling load cap, reduce the estimated seasonal load for the particular day to the cooling load cap.

20. A computer program product for disaggregating seasonal load from overall electricity consumption, the computer program product comprising at least one non-transitory computer-readable storage medium storing software instructions that, when executed by a disaggregation system, cause the disaggregation system to:
receive historical data comprising (i) historical daily load data for a residence for a particular time period and (ii) an average temperature at the residence for each day in the particular time period;
fit a data model to the historical data;
calculate, using the data model, an estimated seasonal load for a target time period; and
cause one or more notifications to be provided based on the estimated seasonal load for the target time period.
